(19) United States
(12) Patent Application Publication
(10) Pub. No.: US 2026/0313491 A1
(43) Pub. Date: Oct. 8, 2026

(54) TERMINAL CAPABILITY REPORTING PROCESSING METHOD AND APPARATUS, TERMINAL, AND FIRST ACCESS NETWORK DEVICE

(71) Applicant: VIVO MOBILE COMMUNICATION CO., LTD., Dongguan (CN)

(72) Inventor: Li CHEN, Dongguan (CN)

(73) Assignee: VIVO MOBILE COMMUNICATION CO., LTD., Dongguan, (CN)

(21) Appl. No.: 19/631,349

(22) Filed: Mar. 27, 2026

Related U.S. Application Data
(63) Continuation of application No. PCT/CN2024/120573, filed on Sep. 24, 2024.

(30) Foreign Application Priority Data
Sep. 28, 2023 (CN) 202311274802.7

(51) Int. Cl. H04W 36/00; H04W 36/08; H04W 74/0833; H04W 76/20

(52) U.S. Cl. CPC H04W 36/008355; H04W 36/08; H04W 74/0833; H04W 76/20

(57) ABSTRACT

Provided are a terminal capability reporting processing method and apparatus, a terminal, and a first access network device. The method includes following steps. A terminal transmits target indication information to a first access network device. The target indication information includes at least one of first indication information and second indication information. The second indication information includes at least one of the following: indicating whether the terminal supports terminal capability filtering; indicating that the terminal applies the target filter or the terminal ignores the target filter; and indicating a full characteristic capability. The target capability can be used for a cell to which the terminal is handed over or a cell which is selected or reselected by the terminal.

### CROSS-REFERENCE TO RELATED APPLICATIONS

This application is a continuation of International Patent Application No. PCT/CN2024/120573, filed on Sep. 24, 2024, which claims the priority of Chinese Patent Application No. 202311274802.7 filed in China on Sep. 28, 2023, the entire content of each of which is hereby incorporated by reference for all purposes.

### FIELD

This application belongs to the field of communication technologies, and specifically relates to a terminal capability reporting processing method and apparatus, a terminal, and a first access network device.

### BACKGROUND

In a communication system, a first access network device usually needs to transmit a capability enquiry message to a terminal, to obtain a capability of the terminal.

### SUMMARY

Embodiments of this application provide a terminal capability reporting processing method and apparatus, a terminal, and a first access network device.

In a first aspect, a terminal capability reporting processing method is provided, including:

a terminal transmits target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a second aspect, a terminal capability reporting processing method is provided, including:

a first access network device receives target indication information from a terminal, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a third aspect, a terminal capability reporting processing apparatus is provided, including:

a first transmission module configured to transmit target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a fourth aspect, a terminal capability reporting processing apparatus is provided, including:

a first receiving module configured to receive target indication information from a terminal, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a fifth aspect, a terminal is provided. The terminal includes a processor and a memory. The memory stores a program or an instruction executable on the processor, and the program or the instruction, when executed by the processor, implements the steps of the method as described in the first aspect.

In a sixth aspect, a terminal is provided, including a processor and a communication interface. The communication interface is configured to transmit target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a seventh aspect, a network side device is provided. The network side device includes a processor and a memory. The memory stores a program or an instruction executable on the processor. The program or the instruction, when executed by the processor, implements the steps of the method as described in the second aspect.

In an eighth aspect, a network side device is provided, including a processor and a communication interface, where the communication interface is configured to receive target indication information from a terminal, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In a ninth aspect, a readable storage medium is provided, having a program or an instruction stored therein. The program or the instruction, when executed by a processor, implements the steps of the method as described in the first aspect or implement the steps of the method as described in the second aspect.

According to a tenth aspect, a wireless communication system is provided, including a terminal and a network side device. The terminal may be configured to perform the steps of the method as described in the first aspect, and the network side device may be configured to perform the steps of the method as described in the second aspect.

In an eleventh aspect, a chip is provided. The chip includes a processor and a communication interface. The communication interface is coupled to the processor. The processor is configured to execute a program or an instruction, to implement the method as described in the first aspect or implement the method as described in the second aspect.

According to a twelfth aspect, a computer program/program product is provided. The computer program/program product is stored in a storage medium. The computer program/program product is executed by at least one processor to implement the steps of the method as described in the first aspect, or implement the steps of the method as described in the third aspect.

### BRIEF DESCRIPTION OF THE DRAWINGS

FIG. 1 is a block diagram of an applicable wireless communication system according to an embodiment of this application;

FIG. 2 is a schematic flowchart of a terminal capability reporting processing method according to an embodiment of this application;

FIG. 3 is a schematic flowchart of another terminal capability reporting processing method according to an embodiment of this application;

FIG. 4 is a diagram of a structure of a terminal capability reporting processing apparatus according to an embodiment of this application;

FIG. 5 is a diagram of a structure of another terminal capability reporting processing apparatus according to an embodiment of this application;

FIG. 6 is a diagram of a structure of a communication device according to an embodiment of this application;

FIG. 7 is a diagram of a terminal according to an embodiment of this application; and

FIG. 8 is a diagram of a structure of a network side device according to an embodiment of this application.

### DETAILED DESCRIPTION OF EMBODIMENTS

The terms "first" and "second" of this application are used to distinguish similar objects, but are not used to describe a specific sequence or order. It should be understood that the terms used in this way may be transposed where appropriate, so that embodiments of this application may be implemented in a sequence other than those illustrated or described herein. In addition, objects defined by "first" and "second" are generally of the same class and do not limit a quantity of objects. For example, one or more first objects may be arranged. In addition, "or" in this application indicates at least one of connected objects. For example, "A or B" covers three solutions, that is, solution I: including A and excluding B; solution II: including B and excluding A; and solution III: including both A and B. The character "/" in this specification generally indicates an "or" relationship between the associated objects.

The term "indication" of this application may be a direct indication (or an explicit indication), or may be an indirect indication (or an implicit indication). The direct indication may be understood as that a sender explicitly informs a receiver of specific information, operations needing to be performed, request results, or the like in a transmitted instruction. The indirect indication can be understood as that the receiver determines corresponding information based on an indication transmitted by the sender, or makes judgments and determines operations needing to be performed or request results based on those judgment results.

It should be noted that, the technology described in the embodiments of this application is not limited to a long term evolution (Long Term Evolution, LTE)/LTE-advanced (LTE-Advanced, LTE-A) system, but may be further used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access, (Orthogonal Frequency Division Multiple Access, OFDMA), single-carrier frequency-division multiple access (Single-carrier Frequency-Division Multiple Access, SC-FDMA), or other systems. The terms "system" and "network" in the embodiments of this application are usually interchangeably used, and the technologies described may be applied to the systems and radio technologies mentioned above and may alternatively be applied to other systems and radio technologies. A new radio (New Radio, NR) system is described below as an example, and the term NR is used in most of the following descriptions. Nevertheless, the technologies may be applied to a system other than the NR system, such as a 6^{th} generation (6^{th} Generation, 6G) communication system.

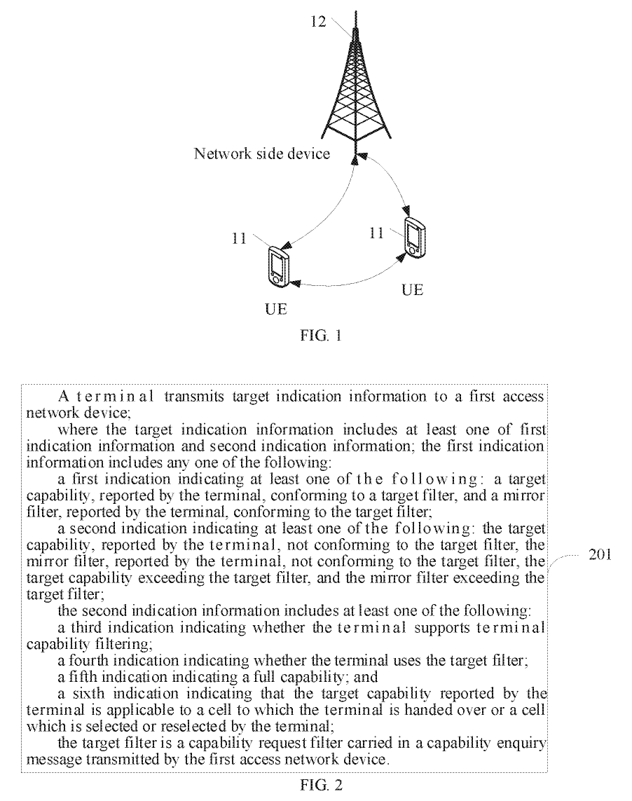

FIG. 1 shows a block diagram of an applicable wireless communication system according to an embodiment of this application. The wireless communication system includes a terminal 11 and a first access network device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR), virtual reality (Virtual Reality, VR) device, a robot, a wearable device (Wearable Device), a flight vehicle (flight vehicle), a vehicle user equipment (Vehicle User Equipment, VUE), a ship-borne device, a pedestrian user equipment (Pedestrian User Equipment, PUE), a smart home appliance (a home device with a wireless communication capability, such as a refrigerator, a television, a washing machine, or furniture), a game console, a personal computer (Personal Computer, PC), a teller machine, or a self-service machine. The wearable device includes: a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The VUE may be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in the embodiments of this application. The first access network device 12 may include an access network device or a core network device. The access network device may alternatively be referred to as a radio access network (Radio Access Network, RAN) device, a radio access network function, or a radio access network unit. The access network device may include a base station, a wireless local area network (WLAN) access point (AP), a wireless fidelity (WiFi) node, or the like. The base station may be referred to as a node B (Node B, NB), an evolved node B (Evolved Node B, eNB), the next generation Node B (the next generation Node B, gNB), a new radio node B (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home node B (home Node B, HNB), a home evolved Node B (home evolved Node B), a transmission reception point (Transmission Reception Point, TRP), or any other appropriate term in the art, provided that the same technical effect is achieved. The base station is not limited to a particular technical term. It should be noted that in the embodiments of this application, only the base station in the NR system is used as an example for description, and a specific type of the base station is not limited.

For ease of understanding, some contents in embodiments of this application are described below.

I. About reporting of a terminal capability request filter (UE capability request filter)

After receiving a capability enquiry message of a first access network device, a terminal performs combined reporting based on frequency ranges, functions, and function groups that are supported by the terminal. If an NR or a universal mobile telecommunications system (Universal Mobile Telecommunications System, UMTS) evolved universal terrestrial radio access (Evolved Universal Terrestrial Radio Access, E-UTRA) network requests a terminal (such as user equipment, UE) capability for an nr, eutra-nr, or eutra, the terminal may perform a terminal processing flow. The terminal processing flow may be performed once for each requested rat-Type.

The terminal processing flow is as follows:

First, the terminal compiles a terminal capability based on a terminal capability request filter in a capability enquiry message and generates a terminal capability matching the filter.

Then, the terminal reports the terminal capability, which includes a filtered terminal capability. Meanwhile, the terminal may further report a mirror filter. The mirror filter may be the same as the terminal capability request filter in the capability enquiry message transmitted by a network.

Optionally, for a specific process in which the terminal compiles the terminal capability, refer to the related technology, and details are not described herein again.

II. About ignoring of a filter

At present, a radio resource control (Radio Resource Control, RRC) regulates and defines a processing delay requirement of an RRC process. A performance requirement is represented as duration from time of receiving a downlink (Downlink, DL) RRC message to time at which the terminal should prepare an UL grant (UL Grant) for receiving an uplink (Uplink, UL) RRC response message. In different RRC processes, a delay requirement of a terminal capability transmission process is the longest, that is, 80ms, and a delay requirement of a simplest RRC reconfiguration process is 10ms.

A basic principle of this delay requirement derives from the fact that the terminal capability transmission process involves "terminal capability filtering". That is, the terminal needs to customize content of a reported terminal capability based on a filter notified by the network. For example, the terminal is requested to report a band list of the terminal capability. The process has a high requirement on a processing capability and an internal memory of the terminal. Therefore, a relatively long processing delay is allowed.

A terminal capability filtering function is originally to solve a continuous increase in a terminal capability size due to carrier aggregation, and ensure that a total terminal capability size fits within a maximum size of a packet data convergence protocol (Packet Data Convergence Protocol, PDCP) service data unit (Service Data Unit, SDU). However, in a case of an enhanced reduced capability (eRedCap), assuming that the terminal only supports a single component carrier (CC) operation, if the terminal only reports a terminal capability related to the single CC operation, the total terminal capability size is much less than the maximum size of the PDCP SDU (9KB). If the terminal supports 29 ranges, the size is 1.6KB. This actually means that the terminal capability filtering does not provide too many benefits.

In a current terminal capability transmission process, the terminal reports capability signaling based on a received capability inquiry, and the terminal reports supportedBandList in the terminal capability. The list includes all bands that can be supported by the terminal.

In a current terminal capability filtering process, the terminal compiles "candidate band combinations" based on a capability filtering criteria received from the capability inquiry. A received terminal capability filter (frequencyBandListFilter) provided by the network side through the capability inquiry may be mirrored to the capability reported by the terminal. The terminal filters a supported band combination list (supportedBandCombinationList) based on a mirrored terminal capability filter. The terminal capability filtering may alternatively affect "candidate characteristic setcombinations".

Therefore, a simple implementation is as follows: The terminal simply ignores the terminal capability filter and reports full supported (non-CA) band combinations and associated feature sets. It is beneficial to inform the network that the terminal has already included all the supported band combinations and the associated feature sets into the terminal capability, so that the network does not re-query the terminal capability.

An optional simplest mechanism of the terminal capability filter is to allow the terminal to change or modify an apply frequency band list filter (applyFreqBandListFilter), so as to include all the ranges supported by the terminal into the supportedBandList, instead of querying a mirror range list filter from the capability. The network may identify that a mirror capability filter includes all ranges (as shown in the supportedBandList) supported by the terminal, and may determine that the terminal capability does not need to be queried again.

A terminal capability reporting processing method provided in an embodiment of this application will be described below through some embodiments and their application scenarios in combination with the accompanying drawings.

Referring to FIG. 2, an embodiment of this application provides a terminal capability reporting processing method. As shown in FIG. 2, the terminal capability reporting processing method includes:

Step 201: A terminal transmits target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

In this embodiment of this application, in a case that the first indication indicates that the target capability reported by the terminal conforms to the target filter, it can be understood that it is indicated by using the target indication information that the reported target capability conforms to the target filter. In this case, the terminal may report the target capability based on the target filter.

For example, the target filter is a filter for band combination (Band Combination, BC), and a BC supported in the target capability reported by the terminal only includes a BC of the target filter or a BC corresponding to the target filter.

For example, the target filter is a filter for band, and a band supported in the target capability reported by the terminal only includes a band of the target filter or a band corresponding to the target filter.

For example, the target filter is a filter for radio access technology (Radio Access Technology, RAT), and an RAT supported in the target capability reported by the terminal only includes an RAT of the target filter or an RAT corresponding to the target filter.

For example, the target filter is a filter for a feature set, and a feature set supported in the target capability reported by the terminal only includes a feature set of the target filter or a feature set corresponding to the target filter.

Optionally, in a case that the first indication indicates that the mirror filter reported by the terminal conforms to the target filter, it can be understood that: it is indicated by using the target indication information that the reported mirror filter conforms to the target filter, or it is indicated by using the target indication information that the reported mirror filter is the same as the target filter.

Optionally, that the target capability reported by the terminal does not conform to the target filter may be understood as or replaced by: the target capability reported by the terminal is different from a capability generated after filtering by the target filter. In a case that the second indication indicates that the target capability reported by the terminal does not conform to the target filter, it can be understood that it is indicated by using the target indication information that the reported target capability does not conform to the target filter, or it is indicated by using the target indication information that the target capability reported by the terminal is different from a capability generated after filtering by the target filter. In this case, the terminal does not report the target capability based on the target filter.

For example, the target filter is a filter for BC, and a BC supported in the target capability reported by the terminal does not conform to a BC of the target filter or a BC corresponding to the target filter.

For example, the target filter is a filter for band, and a band supported in the target capability reported by the terminal does not conform to a band of the target filter or a band corresponding to the target filter.

For example, the target filter is a filter for RAT, and an RAT supported in the target capability reported by the terminal does not conform to an RAT of the target filter or an RAT corresponding to the target filter.

For example, the target filter is a filter for a feature set, and a feature set supported in the target capability reported by the terminal does not conform to a feature set of the target filter or a feature set corresponding to the target filter.

Optionally, the above RAT may include NR, eUtra, Utra, EN-DC, 6G RAT, and the like. This is not further limited herein.

Optionally, that the mirror filter reported by the terminal does not conform to the target filter may be understood as or replaced by that the mirror filter reported by the terminal is different from the target filter. Optionally, in a case that the second indication indicates that the mirror filter reported by the terminal does not conform to the target filter, it can be understood that: it is indicated by using the target indication information that the reported mirror filter does not conform to the target filter, or it is indicated by using the target indication information that the mirror filter reported by the terminal is different from a capability generated after filtering by the target filter.

Optionally, that the target capability exceeds the target filter may be understood as or replaced by: the target capability exceeds a capability (which may alternatively be referred to as a capability of the target filter) generated after filtering by the target filter. That is, the terminal may report the target capability in a manner that the target capability exceeds the target filter. The above exceeding means that the target capability further includes a capability of at least one particular characteristic in addition to the capability of the target filter. The particular characteristic is another characteristic except a characteristic corresponding to the capability of the target filter. For example, in some embodiments, in addition to the capability of the target filter, the terminal may further report a capability required by a second access network device.

Optionally, in a case that the second indication indicates that the mirror filter exceeds the target filter, the terminal may report the mirror filter in a manner that the mirror filter exceeds the target filter.

Optionally, in some embodiments, the above full characteristic capability includes at least one of the following:

all ranges or bands supported by the terminal;

all band combinations (BC) supported by the terminal;

all radio access technologies (RATs) supported by the terminal; and

all feature sets (Feature set) supported by the terminal.

Optionally, in some embodiments, the full characteristic capability is full supported capabilities corresponding to a target characteristic, and the target characteristic is a characteristic corresponding to the target filter. In this embodiment of this application, in a case that the full characteristic capability is indicated, the target capability transmitted by the terminal is the full characteristic capability, and the full characteristic capability corresponds to all the supported capabilities corresponding to the characteristic corresponding to the target filter. It specifically includes at least one of the following:

if the characteristic corresponding to the target filter is a frequency range or a band, the full characteristic capability here refers to all bands supported by the terminal;

if the characteristic corresponding to the target filter is a frequency range or band combination, the full characteristic capability here refers to all band combinations supported by the terminal;

if the characteristic corresponding to the target filter is an RAT, the full characteristic capability here refers to all RATs supported by the terminal; and

if the characteristic corresponding to the target filter is a feature set, the full characteristic capability here refers to all feature sets supported by the terminal.

Optionally, the second indication information and the first indication information may perform joint indication. For example, in some embodiments, it may be indicated by using the target indication information that the target capability is a full characteristic capability, and the target capability conforms to the target filter. Specifically, the target capability is reported based on the target filter.

For another example, in some embodiments, it may be indicated by using the target indication information that the target capability is a full characteristic capability, and the mirror filter conforms to the target filter.

Optionally, for the above third indication: whether terminal capability filtering is supported may be understood as or replaced by: whether the terminal may report a corresponding terminal capability (that is, the target capability) based on the target filter, or may be understood as or replaced by whether a capability filter is supported. The third indication may specifically implement indication in an explicit manner. For example, different bit values are used to indicate whether terminal capability filtering is supported. If a bit value is 1 (or true), it indicates that the terminal capability filtering is supported, and if a bit value is 0 (or false), it indicates that terminal capability filtering is not supported.

Or, in some embodiments, if a bit value is 1 (or true), it indicates that the terminal capability filtering is not supported, and if a bit value is 0 (or false), it indicates that the terminal capability filtering is supported. This embodiment has an advantage of better backward compatibility, because existing terminals all support terminal capability filtering. However, for a newly introduced terminal or a newly introduced characteristic, the terminal possibly may not support terminal capability filtering. Therefore, setting the ratio value to 1 or to be true indicates that terminal capability filtering is not supported. On the contrary, it indicates that the terminal supports terminal capability filtering.

Or, the third indication may implement indication in an implicit manner. For example, if information transmitted by the terminal carries a corresponding indication, or if the information transmitted by the terminal carries the third indication, it indicates that terminal capability filtering is supported. If the information transmitted by the terminal does not carry a corresponding indication, or if the information transmitted by the terminal does not carry the third indication, it indicates by default that terminal capability filtering is not supported. Or, in some embodiments, if information transmitted by the terminal carries a corresponding indication, or if the information transmitted by the terminal carries the third indication, it indicates that terminal capability filtering is not supported. If the information transmitted by the terminal does not carry a corresponding indication, or if the information transmitted by the terminal does not carry the third indication, it indicates by default that terminal capability filtering is supported. This embodiment has an advantage of better backward compatibility, because existing terminals all support terminal capability filtering. However, for a newly introduced terminal or a newly introduced characteristic, the terminal possibly may not support terminal capability filtering. Therefore, carrying this indication or carrying the third indication indicates that terminal capability filtering is not supported. On the contrary, it indicates that the terminal supports terminal capability filtering.

It should be understood that the corresponding indication may be understood as an indication associated with the third indication, for example, the first indication or the second indication. The information transmitted by the terminal may be the target indication information, or a message associated with the target indication information, such as a capability message. For example, in some embodiments, the target indication information indicates, based on whether the target indication information carries the third indication, whether the terminal supports terminal capability filtering, where in a case that the target indication information carries the third indication, the target indication information indicates that the terminal does not support terminal capability filtering; and in a case that the target indication information does not carry the third indication, the target indication information indicates that the terminal supports terminal capability filtering.

Optionally, the fourth indication may implement indication in an explicit manner. For example, whether the target filter is used is indicated by using different bit values. If a bit value is 1 (or true), it indicates that the target filter has been used, and if a bit value is 0 (or false), it indicates that the target filter is not used.

Or, in some embodiments, if a bit value is 1 (or true), it indicates that the target filter is not used, and if a bit value is 0 (or false), it indicates that the target filter has been used. This embodiment has an advantage of better backward compatibility, because existing terminals all have used the target filter. However, for a newly introduced terminal or a newly introduced characteristic, the terminal possibly may not use the target filter. Therefore, setting the ratio value to 1 or to be true indicates that the target filter is not used. On the contrary, it indicates that the terminal has used the target filter.

Or, the fourth indication may implement indication in an implicit manner. For example, if information transmitted by the terminal carries a corresponding indication, or if the information transmitted by the terminal carries the fourth indication, it indicates that the target filter has been used. If the information transmitted by the terminal does not carry a corresponding indication, or if the information transmitted by the terminal does not carry the fourth indication, it indicates by default that the target filter is not used. Or, in some embodiments, if information transmitted by the terminal carries a corresponding indication, or if the information transmitted by the terminal carries the fourth indication, it indicates that the target filter is not used. If the information transmitted by the terminal does not carry a corresponding indication, or if the information transmitted by the terminal does not carry the fourth indication, it indicates by default that the target filter has been used. This embodiment has an advantage of better backward compatibility, because existing terminals all have used the target filter. However, for a newly introduced terminal or a newly introduced characteristic, the terminal possibly may not use the target filter. Therefore, carrying this indication or carrying the fourth indication indicates that the target filter is not used. On the contrary, it indicates that the terminal has used the target filter.

It should be understood that the information transmitted by the terminal may be the target indication information, or a message associated with the target indication information, such as a capability message. For example, in some embodiments, the target indication information indicates, based on whether the target indication information carries the fourth indication, that the terminal applies the target filter or the terminal ignores the target filter, where in a case that the target indication information carries the fourth indication, the target indication information indicates that the terminal does not use the target filter; and in a case that the target indication information does not carry the fourth indication, the target indication information indicates that the terminal has used the target filter.

For the above sixth indication, in a case that the target indication information includes the sixth indication, in addition to the capability of the target filter, the terminal may further report a capability required by a second access network device. In this case, the first access network device may correctly understand, based on the sixth indication, the target capability reported by the terminal. Meanwhile, in a case that the terminal moves to a cell corresponding to the second access network device, the terminal may not need to report a terminal capability again, and meanwhile, the second access network device also does not need to re-query a terminal capability, thereby reducing signaling overheads.

It should be noted that the first access network device may be understood as an access network device corresponding to a current serving cell of the terminal or an access network device receiving the target capability, and the second access network device may be understood as another access network device except the first access network device, for example, an access network device corresponding to a neighboring cell of the terminal.

In the embodiments of this application, a terminal transmits target indication information to a first access network device, where the target indication information includes at least one of first indication information and second indication information; the first indication information includes any one of the following: a first indication indicating at least one of the following a target capability, reported by the terminal, conforming to a target filter, and a mirror filter, reported by the terminal, conforming to the target filter; and a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter; the second indication information includes at least one of the following: a third indication indicating whether the terminal supports terminal capability filtering; a fourth indication indicating that the terminal applies the target filter or the terminal ignores the target filter; a fifth indication indicating a full characteristic capability; and a sixth indication indicating that the target capability reported by the terminal may be used for a cell to which the terminal is handed over or a cell which is selected or reselected by the terminal, where the target filter is a capability request filter carried in a capability enquiry message transmitted by the first access network device. In this way, when a capability of the terminal is insufficient or the terminal needs to report another capability except a capability required to be reported by the capability enquiry message, a capability can be reported based an actual need. In this case, the first access network device can understand the capability reported by the terminal based on the target indication information, thus ensuring correctness of understanding by the first access network device on the target capability reported by the terminal.

Optionally, in some embodiments, the method further includes:

The terminal receives the capability enquiry message (i.e. terminal capability enquiry) from the first access network device, where the capability enquiry message carries the target filter (i.e. terminal-CapabilityRequestFilter).

The terminal transmits a capability message to the first access network device based on the capability enquiry message, where the capability message includes the target capability.

Optionally, in some embodiments, the target indication information is implicitly indicated through the mirror filter, and the target indication information satisfies at least one of the following:

in a case that the mirror filter is different from the target filter, the target indication information indicates at least one of the following: the terminal not supporting terminal capability filtering, the terminal not applying the target filter, and the target capability being the full characteristic capability; and

in a case that the mirror filter is the same as the target filter, the target indication information indicates at least one of the following: the terminal supporting terminal capability filtering, the terminal having used the target filter, and the target capability being the full characteristic capability.

It should be understood that in this embodiment of this application, the capability message needs to include the mirror filter, and the target indication information may be implicitly indicated based on the mirror filter, thereby reducing signaling overheads.

It should be noted that in some embodiments, the target indication information is associated with target information reported by the terminal. The target information includes at least one of the target capability and the mirror filter.

Optionally, in some embodiments, the target capability includes at least one of the following:

a first capability or a second capability; and

a third capability, where

the first capability includes at least one of the following: a capability conforming to the target filter; and the mirror filter conforming to the target filter;

the second capability includes at least one of the following: a capability not conforming to the target filter; and the mirror filter not conforming to the target filter; and

the third capability includes at least one of the following: a capability exceeding the target filter; a capability corresponding to the mirror filter exceeding the target filter; a full characteristic capability; and a capability may be used for a cell to which the terminal is handed over or a cell which is selected or reselected by the terminal.

In this embodiment of this application, specific content of the target capability corresponds to the target indication information, that is, the target capability matches the target indication information. For example, in a case that the target indication information includes the first indication, the target capability corresponds to the first capability. That is, in a case that it is indicated by using the target indication information that the target capability reported by the terminal conforms to the target filter, the target capability is the capability conforming to the target filter. In a case that it is indicated by using the target indication information that the mirror filter reported by the terminal conforms to the target filter, the target capability is the mirror filter conforming to the target filter.

Optionally, the capability conforming to the target filter may be understood as or replaced by a capability conforming to a filter carried in the capability enquiry message, that is, a capability generated based on the target filter.

Optionally, the mirror filter conforming to the target filter may be understood as or replaced by a mirrored filter conforming to the filter carried in the capability enquiry message.

Optionally, the capability not conforming to the target filter may be understood as or replaced by a capability not conforming to the filter carried in the capability enquiry message, or different from a capability generated after filtering by the filter carried in the capability enquiry message.

Optionally, the mirror filter not conforming to the target filter may be understood as or replaced by a mirrored filter not conforming to the filter carried in the capability enquiry message.

Optionally, the capability exceeding the target filter refers to a capability exceeding the capability of the target filter. Further, the capability exceeding the target filter may be understood as or replaced by a capability exceeding the capability corresponding to the filter carried in the capability enquiry message, or exceeding the capability generated after filtering by the filter carried in the capability enquiry message.

Optionally, the capability corresponding to the mirror filter exceeding the target filter may be understood as or replaced by a capability exceeding a mirrored filter of the filter carried in the capability enquiry message.

Optionally, in some embodiments, the target capability may include a combination of at least two of the first capability, the second capability, and the third capability. For example, in some embodiments, the target capability may include the full characteristic capability, and the target capability conforms to the target filter. Specifically, the target capability is reported based on the target filter. For example, in some embodiments, the target capability may include the full characteristic capability, and the mirror filter conforms to the target filter.

Optionally, in some embodiments, the target indication information is carried in a target message, and the target message includes at least one of the following:

a capability message, where the capability message is used for reporting the target capability;

a terminal assistance information (terminal Assistance Information, UAI) message;

a radio resource control (Radio Resource Control, RRC) message; and

an uplink message in a random access channel (Random Access Channel, RACH) process.

Optionally, in a case that the target message includes the capability message, it can be understood that the terminal carries the target indication information during capability reporting.

Optionally, when the target message includes the RRC message, the target indication information may be reported in a connection establishment message. The RRC message may be understood as a UL RRC message.

Optionally, the uplink message may include at least one of message 1 (msg1), msg3, or msgA. That is, the terminal is instructed in the RACH process to report a capability that is previously reported to a network or is stored in the network, specifically refer to the above target capability.

Optionally, in some embodiments, the target filter and the mirror filter are configured to filter at least one of the following characteristics:

a supported frequency range or band;

a supported band combination;

a supported radio access technology; and

a supported feature set.

Optionally, in some embodiments, a type of the terminal includes at least one of the following:

a reduced-capability terminal or an enhanced reduced-capability terminal;

an Internet of Things (Internet of Things, IoT) terminal;

a vehicle to everything (Vehicle to Everything, V2X) terminal;

a device to device (Device to Device, D2D) terminal; and

a non-terrestrial network (non-terrestrial network, NTN) terminal.

Optionally, in another embodiment, the terminal may alternatively be an ordinary terminal, that is, a 3G terminal, a 4G terminal, a 5G terminal, a 6G terminal, or the like.

Optionally, the IoT terminal may include a narrow band Internet of Things (Narrow Band Internet of Things, NBIoT) terminal, a machine-type communication (Machine-Type Communication, MTC) terminal, an artificial intelligence Internet of Things (AIoT) terminal, and the like.

Optionally, in some embodiments, in a case that a preset condition is satisfied, the target indication information includes the second indication; and the preset condition includes at least one of the following:

a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a feature set supported by the terminal is limited; and the terminal has obtained a terminal capability required by a second access network device.

In this embodiment of this application, that a processing delay of the terminal exceeds a preset threshold may be understood as the processing delay of the terminal being excessively large, and that a capability supported by the terminal is limited may be understood as supporting a reduced capability.

It should be noted that the above being limited may be understood as at least one of the following: less, smaller, less than a preset threshold, smaller than a preset threshold, less than an ordinary terminal, or smaller than an ordinary terminal.

Optionally, in some embodiments, in a case that the terminal has obtained the terminal capability required by the second access network device, the target capability includes at least one of the following: a capability conforming to the target filter, the terminal capability required by the second access network device, and the full characteristic capability;

or, in a case that the terminal has obtained the terminal capability required by the second access network device, the target indication information includes the second indication.

For example, in some embodiments, in a case that the terminal has obtained the terminal capability required by the second access network device, at least one of the following can be performed:

reporting the full characteristic capability, and reporting at least one of the second indication, the third indication, the fourth indication, the fifth indication, and the sixth indication; and

reporting the capability conforming to the target filter and the terminal capability required by the second access network device, and reporting at least one of the second indication, the third indication, the fourth indication, the fifth indication, and the sixth indication.

That is, when the terminal reports the capability not conforming to the target filter, and the reported capability is not the full characteristic capability (i.e. full Capability), the terminal needs to report the target indication information. For example, the terminal knows a configuration of a band of a neighboring cell. In this way, only bands to be used by the serving cell and the neighboring cell are reported, rather than full supported bands (full supported band). In this way, the terminal does not need to perform reporting again after moving to another cell. In addition, the network does not need to re-query the capability of the terminal (enquiry terminal).

Optionally, in this embodiment of this application, after the terminal is handed over to or reselects a cell corresponding to the second access network device, the terminal does not need to report the capability of the terminal. Further, the capability of the terminal may be transmitted from a core network to a second cell or the second access network device.

Optionally, in some embodiments, the target capability reported by the terminal conforms to the capability (Capability) of the target filter, or the mirror filter reported by the terminal conforms to the target filter. In addition, the target capability reported by the terminal is exactly the full characteristic capability of the characteristic corresponding to the target filter (for example, the characteristic corresponding to the target filter is a band, a BC, an RAT, or a feature set, and the reported target capability is full bands, BCs, RATs, or feature sets supported by the terminal). In this case, the target indication information includes at least one of the first indication and the fifth indication.

Further, after the first access network device receives the target capability and the target indication information, the terminal identifies that the target capability is the full characteristic capability supported by the terminal, and a network side identifies that the target capability is the full characteristic capability supported by the terminal. The terminal does not need to report a capability after moving to the second cell corresponding to the second access network device.

Optionally, in some embodiments, since internal implementation of the terminal may have an error or reporting may have an error, the first access network device may perform a corresponding behavior based on content reported by the terminal. For example, the first access network device executes a first behavior in a case that the target indication information does not match the target capability; and

the first access network device executes a second behavior in a case that the target indication information matches the target capability.

The first behavior includes at least one of the following:

determining that the target capability is invalid;

determining not to transmit the target capability to a target device, where the target device includes at least one of the second access network device and the core network device; and

transmitting the capability enquiry message to the terminal.

The second behavior includes at least one of the following:

determining that the target capability is valid;

transmitting the target capability to the target device, where the target device includes at least one of the second access network device and the core network device; and

determining not to retransmit the capability enquiry message to the terminal.

In this embodiment of this application, that the target indication information does not match the target capability may be understood as at least one of the following:

in a case that the target indication information indicates the first indication, the reported target capability is the second capability;

in a case that the target indication information indicates the second indication, the reported target capability is the first capability; and

in a case that the target indication information indicates the full characteristic capability, the reported target capability is a non-full characteristic capability.

Optionally, in some implementations, in a case that the target indication information matches the target capability, the second access network device or the cell corresponding to the second access network device determines that the target capability reported by the terminal is valid.

Optionally, in some implementations, in a case that the target indication information does not match the target capability, the second access network device or the cell corresponding to the second access network device determines that the target capability reported by the terminal is invalid.

It should be understood that in a case that the target indication information does not match the target capability, the first access network device may transmit a capability enquiry message to the terminal, to re-query a capability of the terminal.

Further, in a case that the target indication information does not match the target capability, if the core network receives the target capability, the core network device may not transmit the target capability of the terminal to the second access network device.

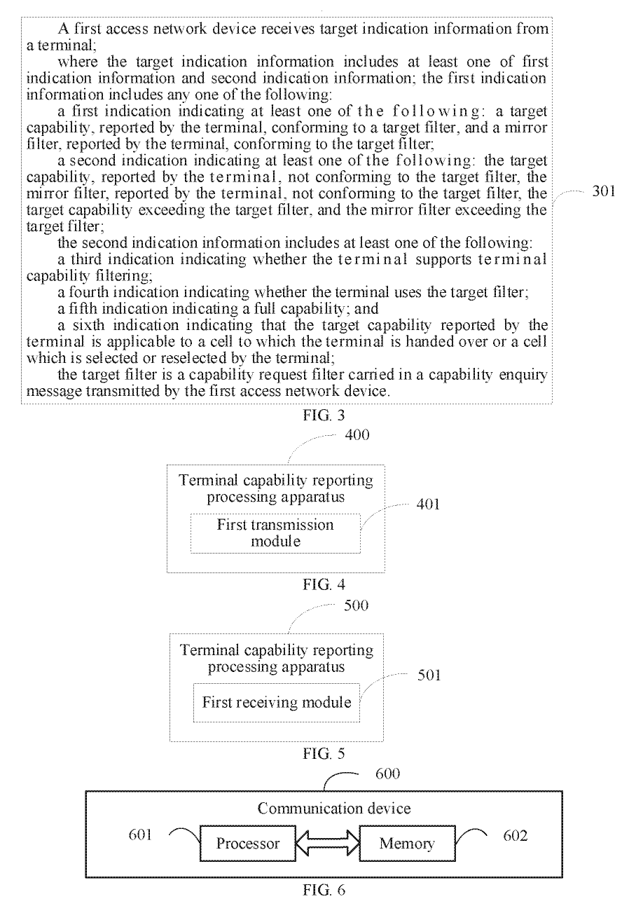

Referring to FIG. 3, an embodiment of this application further provides a terminal capability reporting processing method. As shown in FIG. 3, the method includes:

Step 301: A first access network device receives target indication information from a terminal, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

Optionally, the method further includes:

The first access network device transmits a capability enquiry message to the terminal, where the capability enquiry message carries the target filter.

The first access network device receives a capability message from the terminal, where the capability message includes the target capability.

Optionally, the target indication information is implicitly indicated through the mirror filter, and the target indication information satisfies at least one of the following:

in a case that the mirror filter is different from the target filter, the target indication information indicates at least one of the following: the terminal not supporting terminal capability filtering, the terminal not applying the target filter, and the target capability being the full characteristic capability; and

in a case that the mirror filter is the same as the target filter, the target indication information indicates at least one of the following: the terminal supporting terminal capability filtering, the terminal having used the target filter, and the target capability being the full characteristic capability.

Optionally, the target capability includes at least one of the following:

a first capability or a second capability; and

a third capability, where

the first capability includes at least one of the following: a capability conforming to the target filter; and the mirror filter conforming to the target filter;

the second capability includes at least one of the following: a capability not conforming to the target filter; and the mirror filter not conforming to the target filter;

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

Optionally, the target indication information is carried in a target message, and the target message includes at least one of the following:

a capability message, where the capability message is used for reporting the target capability;

a terminal assistance information UAI message;

radio resource control RRC message; and

an uplink message in a random access channel RACH process.

Optionally, the target filter and the mirror filter are configured to filter at least one of the following characteristics:

a supported frequency range or band;

a supported band combination;

a supported radio access technology; and

a supported feature set.

For example, the target indication information indicates, based on whether the target indication information carries the third indication, whether the terminal supports terminal capability filtering, where in a case that the target indication information carries the third indication, the target indication information indicates that the terminal does not support terminal capability filtering; and in a case that the target indication information does not carry the third indication, the target indication information indicates that the terminal supports terminal capability filtering.

Optionally, the target indication information indicates, based on whether the target indication information carries the fourth indication, that the terminal applies the target filter or the terminal ignores the target filter, where in a case that the target indication information carries the fourth indication, the target indication information indicates that the terminal does not use the target filter; and in a case that the target indication information does not carry the fourth indication, the target indication information indicates that the terminal has used the target filter.

Optionally, the above full characteristic capability includes at least one of the following:

all ranges or bands supported by the terminal;

all band combinations supported by the terminal;

all radio access technologies supported by the terminal; and

all feature sets supported by the terminal.

Optionally, in some embodiments, the full characteristic capability is full supported capabilities corresponding to a target characteristic, and the target characteristic is a characteristic corresponding to the target filter.

Optionally, after the first access network device receives the target indication information from the terminal, the method further includes:

The first access network device transmits the target indication information or both the target indication information and the target capability to a target device, where

the target device includes at least one of a core network device and a second access network device.

Optionally, that the first access network device transmits the target indication information or both the target indication information and the target capability to a target device includes:

The first access network device transmits the target indication information or both the target indication information and the target capability to the target device in a case that the target indication information includes the second indication information or the second indication indicates that the target capability is the full characteristic capability.

Optionally, after the first access network device receives the target indication information from the terminal, the method further includes:

The first access network device determines, based on the target indication information, that the terminal satisfies a preset condition, where

the preset condition includes at least one of the following: a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a feature set supported by the terminal is limited; and the terminal has obtained a terminal capability required by a second access network device.

Optionally, the method further includes at least one of the following:

The first access network device executes a first behavior in a case that the target indication information does not match the target capability.

The first access network device executes a second behavior in a case that the target indication information matches the target capability.

The first behavior includes at least one of the following:

determining that the target capability is invalid;

determining not to transmit the target capability to a target device, where the target device includes at least one of the second access network device and the core network device; and

transmitting the capability enquiry message to the terminal.

The second behavior includes at least one of the following:

determining that the target capability is valid;

transmitting the target capability to the target device, where the target device includes at least one of the second access network device and the core network device; and

determining not to retransmit the capability enquiry message to the terminal.

An embodiment of this application further provides a terminal capability reporting processing method, including:

A terminal transmits a capability message to a first access network device, where the capability message includes a target capability.

The target capability includes at least one of the following:

a second capability; and

a third capability, where

the second capability includes at least one of the following: a capability not conforming to a target filter; and a mirror filter not conforming to the target filter; and

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

In this embodiment of this application, since a specific definition of the target capability that is compiled and reported by the terminal not based on the target filter is clarified, a problem that the terminal cannot perform capability reporting based on the target filter carried in a capability enquiry message due to an insufficient capability of the terminal can be solved. Therefore, flexibility of capability reporting is enhanced, and the terminal can access more scenarios and networks. Specifically, in this embodiment of this application, for a specific understanding of each capability, a definition of the terminal, and the like, refer to the above embodiments, and details are not described herein again.

An embodiment of this application further provides a terminal capability reporting processing method, including:

A first access network device receives a capability message from a terminal, where the capability message includes a target capability.

The target capability includes at least one of the following:

a second capability; and

a third capability, where

the second capability includes at least one of the following: a capability not conforming to a target filter; and a mirror filter not conforming to the target filter; and

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

For the terminal capability reporting processing method provided in this embodiment of this application, an executive entity may be a terminal capability reporting processing apparatus. In the embodiments of this application, using the terminal capability reporting processing apparatus to perform the terminal capability reporting processing method is taken as an example to explain the terminal capability reporting processing apparatus provided in the embodiments of this application.

Referring to FIG. 4, an embodiment of this application provides a terminal capability reporting processing apparatus. As shown in FIG. 4, the terminal capability reporting processing apparatus 400 includes:

a first transmission module 401 configured to transmit target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

Optionally, the terminal capability reporting processing apparatus 400 further includes:

a second receiving module configured to receive the capability enquiry message from the first access network device, where the capability enquiry message carries the target filter.

The first transmission module 401 is further configured to transmit a capability message to the first access network device based on the capability enquiry message, where the capability message includes the target capability.

Optionally, the target indication information is implicitly indicated through the mirror filter, and the target indication information satisfies at least one of the following:

in a case that the mirror filter is different from the target filter, the target indication information indicates at least one of the following: the terminal not supporting terminal capability filtering, the terminal not applying the target filter, and the target capability being the full characteristic capability; and

in a case that the mirror filter is the same as the target filter, the target indication information indicates at least one of the following: the terminal supporting terminal capability filtering, the terminal having used the target filter, and the target capability being the full characteristic capability.

Optionally, the target capability includes at least one of the following:

a first capability or a second capability; and

a third capability, where

the first capability includes at least one of the following: a capability conforming to the target filter; and the mirror filter conforming to the target filter;

the second capability includes at least one of the following: a capability not conforming to the target filter; and the mirror filter not conforming to the target filter; and

the third capability includes at least one of the following: a capability exceeding the target filter; a capability corresponding to the mirror filter exceeding the target filter; a full characteristic capability; and a capability applicable to a cell to which the terminal is handed over or a cell which is selected or reselected by the terminal.

Optionally, the target indication information is carried in a target message, and the target message includes at least one of the following:

a capability message, where the capability message is used for reporting the target capability;

a terminal assistance information UAI message;

radio resource control RRC message; and

an uplink message in a random access channel RACH process.

Optionally, the target filter and the mirror filter are configured to filter at least one of the following characteristics:

a supported frequency range or band;

a supported band combination;

a supported radio access technology; and

a supported feature set.

Optionally, a type of the terminal includes at least one of the following:

a reduced-capability terminal or an enhanced reduced-capability terminal;

an Internet of Things IOT terminal;

a vehicle to everything V2X terminal;

a device to device D2D terminal; and

a non-terrestrial network NTN terminal.

Optionally, in a case that a preset condition is satisfied, the target indication information includes the second indication; and the preset condition includes at least one of the following:

a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a feature set supported by the terminal is limited; and the terminal has obtained a terminal capability required by a second access network device.

Optionally, in a case that the terminal has obtained the terminal capability required by the second access network device, the target capability includes at least one of the following: a capability conforming to the target filter, the terminal capability required by the second access network device, and the full characteristic capability;

or, in a case that the terminal has obtained the terminal capability required by the second access network device, the target indication information includes the second indication.

For example, the target indication information indicates, based on whether the target indication information carries the third indication, whether the terminal supports terminal capability filtering, where in a case that the target indication information carries the third indication, the target indication information indicates that the terminal does not support terminal capability filtering; and in a case that the target indication information does not carry the third indication, the target indication information indicates that the terminal supports terminal capability filtering.

Optionally, the target indication information indicates, based on whether the target indication information carries the fourth indication, that the terminal applies the target filter or the terminal ignores the target filter, where in a case that the target indication information carries the fourth indication, the target indication information indicates that the terminal does not use the target filter; and in a case that the target indication information does not carry the fourth indication, the target indication information indicates that the terminal has used the target filter.

Optionally, the above full characteristic capability includes at least one of the following:

all ranges or bands supported by the terminal;

all band combinations supported by the terminal;

all radio access technologies supported by the terminal; and

all feature sets supported by the terminal.

Optionally, in some embodiments, the full characteristic capability is full supported capabilities corresponding to a target characteristic, and the target characteristic is a characteristic corresponding to the target filter.

Referring to FIG. 5, an embodiment of this application provides a terminal capability reporting processing apparatus. As shown in FIG. 5, the terminal capability reporting processing apparatus 500 includes:

a first receiving module 501 configured to receive target indication information from a terminal, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal may be used for a cell to which the terminal is handed over or a cell which is selected or reselected by the terminal, where

the target filter is a capability request filter carried in a capability enquiry message transmitted by the first access network device.

Optionally, the terminal capability reporting processing apparatus 500 further includes:

a second transmission module configured to transmit a capability enquiry message to the terminal, where the capability enquiry message carries the target filter.

The second receiving module 501 is further configured to receive a capability message from the terminal, where the capability message includes a target capability.

Optionally, the target indication information is implicitly indicated through the mirror filter, and the target indication information satisfies at least one of the following:

in a case that the mirror filter is different from the target filter, the target indication information indicates at least one of the following: the terminal not supporting terminal capability filtering, the terminal not applying the target filter, and the target capability being the full characteristic capability; and

in a case that the mirror filter is the same as the target filter, the target indication information indicates at least one of the following: the terminal supporting terminal capability filtering, the terminal having used the target filter, and the target capability being the full characteristic capability.

Optionally, the target capability includes at least one of the following:

a first capability or a second capability; and

a third capability, where

the first capability includes at least one of the following: a capability conforming to the target filter; and the mirror filter conforming to the target filter;

the second capability includes at least one of the following: a capability not conforming to the target filter; and the mirror filter not conforming to the target filter; and

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

Optionally, the target indication information is carried in a target message, and the target message includes at least one of the following:

a capability message, where the capability message is used for reporting the target capability;

a terminal assistance information UAI message;

radio resource control RRC message; and

an uplink message in a random access channel RACH process.

Optionally, the target filter and the mirror filter are configured to filter at least one of the following characteristics:

a supported frequency range or band;

a supported band combination;

a supported radio access technology; and

a supported feature set.

For example, the target indication information indicates, based on whether the target indication information carries the third indication, whether the terminal supports terminal capability filtering, where in a case that the target indication information carries the third indication, the target indication information indicates that the terminal does not support terminal capability filtering; and in a case that the target indication information does not carry the third indication, the target indication information indicates that the terminal supports terminal capability filtering.

Optionally, the target indication information indicates, based on whether the target indication information carries the fourth indication, that the terminal applies the target filter or the terminal ignores the target filter, where in a case that the target indication information carries the fourth indication, the target indication information indicates that the terminal does not use the target filter; and in a case that the target indication information does not carry the fourth indication, the target indication information indicates that the terminal has used the target filter.

Optionally, the above full characteristic capability includes at least one of the following:

all ranges or bands supported by the terminal;

all band combinations supported by the terminal;

all radio access technologies supported by the terminal; and

all feature sets supported by the terminal.

Optionally, in some embodiments, the full characteristic capability is full supported capabilities corresponding to a target feature, and the target feature is a feature corresponding to the target filter.

Optionally, after the first access network device receives the target indication information from the terminal, the terminal capability reporting processing apparatus 500 further includes:

a second transmission module configured to transmit the target indication information or both the target indication information and the target capability to a target device, where

the target device includes at least one of a core network device and a second access network device.

Optionally, the second transmission module is specifically configured to transmit the target indication information or both the target indication information and the target capability to the target device in a case that the target indication information includes the second indication information or the second indication indicates that the target capability is the full characteristic capability.

Optionally, the terminal capability reporting processing apparatus 500 further includes:

a determination module configured to determine, based on the target indication information, that the terminal satisfies a preset condition, where

the preset condition includes at least one of the following: a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a feature set supported by the terminal is limited; and the terminal has obtained a terminal capability required by a second access network device.

Optionally, the terminal capability reporting processing apparatus 500 further includes an execution module configured to execute at least one of the following:

the first access network device executes a first behavior in a case that the target indication information does not match the target capability; and

the first access network device executes a second behavior in a case that the target indication information matches the target capability.

The first behavior includes at least one of the following:

determining that the target capability is invalid;

determining not to transmit the target capability to a target device, where the target device includes at least one of the second access network device and the core network device; and

transmitting the capability enquiry message to the terminal.

The second behavior includes at least one of the following:

determining that the target capability is valid;

transmitting the target capability to the target device, where the target device includes at least one of the second access network device and the core network device; and

determining not to retransmit the capability enquiry message to the terminal.

An embodiment of this application further provides a terminal capability reporting processing apparatus, including:

a third transmission module configured to transmit a capability message to a first access network device, where the capability message includes a target capability.

The target capability includes at least one of the following:

a second capability; and

a third capability, where

the second capability includes at least one of the following: a capability not conforming to a target filter; and a mirror filter not conforming to the target filter; and

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

An embodiment of this application further provides a terminal capability reporting processing apparatus, including:

a third receiving module configured to receive a capability message from a terminal, where the capability message includes a target capability.

The target capability includes at least one of the following:

a second capability; and

a third capability, where

the second capability includes at least one of the following: a capability not conforming to a target filter; and a mirror filter not conforming to the target filter; and

the third capability includes at least one of the following: a capability exceeding the target filter; a capability corresponding to the mirror filter exceeding the target filter; a full characteristic capability; and a capability used for a cell to which the terminal is handed over or a cell which is selected or reselected by the terminal.

The terminal capability reporting processing apparatus in this embodiment of this application may be an electronic device, for example, an electronic device having an operating system, or a component in an electronic device, such as an integrated circuit or a chip. The electronic device may be a terminal, or may be another device except a terminal. For example, the terminal may include, but is not limited to, the types of the terminal 11 listed above, and the another device may be a server, a network attached storage (Network Attached Storage, NAS), or the like. This is not specifically limited in embodiments of this application.

The terminal capability reporting processing apparatus provided in this embodiment of this application can implement the processes implemented in the method embodiments of FIG. 2 to FIG. 3, and the same technical effect is achieved. To avoid repetition, details are not described herein.

As shown in FIG. 6, an embodiment of this application further provides a communication device 600, including a processor 601 and a memory 602. The memory 602 stores a program or an instruction executable on the processor 601. The program or the instruction, when executed by the processor 601, implements the steps of the terminal capability reporting processing method embodiment, and same technical effects can be achieved. To avoid repetition, details will not be repeated herein.

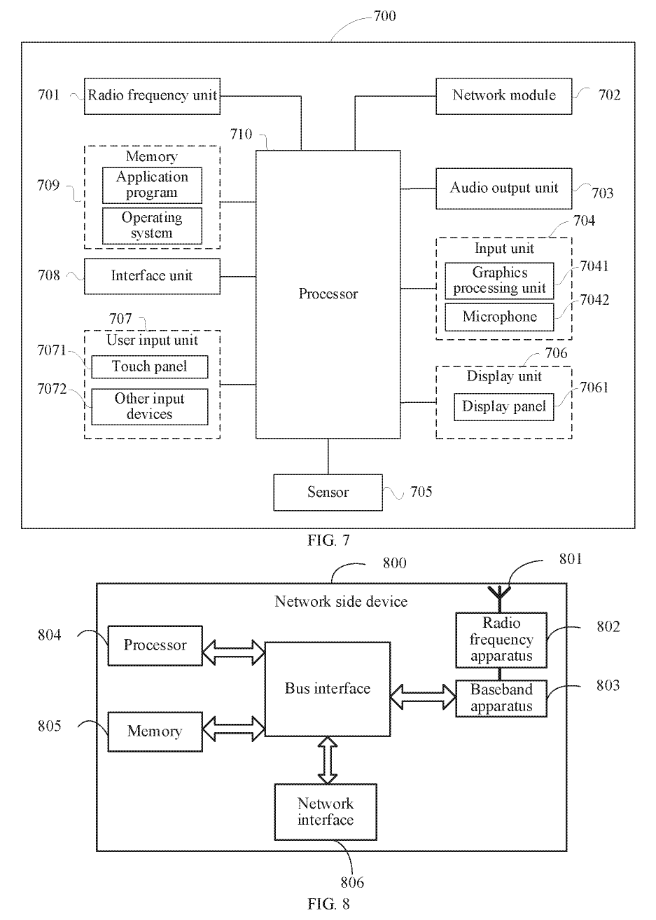

An embodiment of this application further provides a terminal, including a processor and a communication interface, where the communication interface is coupled to the processor, and the processor is configured to execute a program or an instruction, to implement the steps of the method embodiment shown in FIG. 2. The terminal embodiment corresponds to the above terminal-side method embodiment, and the implementation processes and implementations of the method embodiment can be applied to the terminal embodiment, and can achieve the same technical effects. Specifically, FIG. 7 is a diagram of a hardware structure of a terminal for implementing an embodiment of this application.

The terminal 700 includes but is not limited to at least some components of a radio frequency unit 701, a network module 702, an audio output unit 703, an input unit 704, a sensor 705, a display unit 706, a user input unit 707, an interface unit 708, a memory 709, a processor 710, and the like.

A person skilled in the art may understand that the terminal 700 may further include a power supply (such as a battery) for supplying power to the components. The power supply may be logically connected to the processor 710 by a power management system, thereby implementing functions such as charging, discharging, and power consumption management by using the power management system. The terminal structure shown in FIG. 7 does not constitute a limitation on the terminal. The terminal may include more or fewer components than those shown in the figure, or some components may be combined, or different component arrangements may be used. Details are not described herein again.

It should be understood that in the embodiments of this application, the input unit 704 may include a graphics processing unit (Graphics Processing Unit, GPU) 7041 and a microphone 7042, and the GPU 7041 processes image data of static pictures or videos obtained by an image capturing apparatus (such as a camera) in a video capturing mode or an image capturing mode. The display unit 706 may include a display panel 7061. The display panel 7061 may be configured by using a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. Another input device 7072 may include, but is not limited to, a physical keyboard, a functional key (such as a volume control key or a switch key), a track ball, a mouse, and a joystick. Details are not described herein again.

In this embodiment of this application, after receiving downlink data from a network side device, the radio frequency unit 701 may transmit the data to the processor 710 for processing. In addition, the radio frequency unit 701 may transmit uplink data to the network side device. Generally, the radio frequency unit 701 includes, but is not limited to, an antenna, an amplifier, a transceiver, a coupler, a low noise amplifier, a duplexer, and the like.

The memory 709 may be configured to store a software program or instruction and various data. The memory 709 may mainly include a first storage region storing the program or an instruction and a second storage region storing the data. The first storage region may store an operating system, an application program or an instruction required by at least one function (for example, a sound playback function and an image display function), and the like. Moreover, the memory 709 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 709 in the embodiments of this application includes, but is not limited to, these memories and any other memory of a suitable type.

The processor 710 may include one or more processing units. Optionally, the processor 710 integrates an application processor and a modem processor. The application processor mainly processes operations related to an operating system, a user interface, an application, and the like. The modem processor mainly processes wireless communication signals, and is, for example, a baseband processor. It may be understood that the foregoing modem may not be integrated into the processor 710.

The radio frequency unit 701 is configured to transmit target indication information to a first access network device, where

the target indication information includes at least one of first indication information and second indication information; the first indication information includes any one of the following:

a first indication indicating at least one of the following: a target capability, reported by the terminal, conforming to a target filter, and a mirror filter, reported by the terminal, conforming to the target filter; and

a second indication indicating at least one of the following: the target capability, reported by the terminal, not conforming to the target filter, the mirror filter, reported by the terminal, not conforming to the target filter, the target capability exceeding the target filter, and the mirror filter exceeding the target filter;

the second indication information includes at least one of the following:

a third indication indicating whether the terminal supports terminal capability filtering;

a fourth indication indicating that the terminal applies the target filter or the terminal ignores the target filter;

a fifth indication indicating a full characteristic capability; and

a sixth indication indicating that the target capability reported by the terminal is used for a cell to which the terminal is handed over or a cell which is selected or reselected by the terminal, where

the target filter is a capability request filter carried in a capability enquiry message transmitted by the first access network device.

It can be understood that for the implementation processes of the implementations mentioned in this embodiment, refer to the relevant description of the terminal-side method embodiment, and the same or corresponding technical effects can be achieved. To avoid repetition, details are not described herein.

An embodiment of this application further provides a network side device, including a processor and a communication interface, where the communication interface is coupled to the processor, and the processor is configured to execute a program or an instruction, to implement the steps of the method embodiment shown in FIG. 3. The network side device embodiment corresponds to the above first access network device-side method embodiment, and the implementation processes and implementations of the above method embodiment can be applied to the network side device embodiment, and can achieve the same technical effects.

Specifically, an embodiment of this application further provides a network side device. As shown in FIG. 8, the network side device 800 includes: an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801 and transmits the received information to the baseband apparatus 803 for processing. In a downlink direction, the baseband apparatus 803 processes to-be-transmitted information and transmits the to-be-transmitted information to the radio frequency apparatus 802, and the radio frequency apparatus 802 processes the information received and transmits the information through the antenna 801.

The method performed by the network side device in the above embodiments may be implemented in the baseband apparatus 803. The baseband apparatus 803 includes a baseband processor.

The baseband apparatus 803 may include, for example, at least one baseband board, and a plurality of chips are arranged on the baseband board. As shown in FIG. 8, one chip such as the baseband processor is connected to the memory 805 through a bus interface, so as to invoke a program in the memory 805, and perform the operations performed by a network device shown in the above method embodiment.

The network side device may further include a network interface 806. The interface is, for example, a common public radio interface (common public radio interface, CPRI).

Specifically, the network side device 800 in this embodiment of this application further includes: an instruction or a program stored in the memory 805 and executable in the processor 804. The processor 804 invokes the instruction or the program in the memory 805 to perform methods executed by modules shown in FIG. 5, and achieves the same technical effects. To avoid repetition, details are not described herein.

An embodiment of this application further provides a readable storage medium having a program or an instruction stored therein. The program or instruction, when executed by a processor, implements the processes of the terminal capability reporting processing method embodiment, and can achieve the same technical effects. To avoid repetition, details are not described herein.

The processor is the processor in the terminal described in the above embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

An embodiment of this application further provides a chip. The chip includes a processor and a communication interface. The communication interface is coupled to the processor. The processor is configured to execute a program or an instruction to implement the processes of the terminal capability reporting processing method embodiment, and can achieve the same technical effects. To avoid repetition, details are not described herein.

It should be understood that the chip mentioned in the embodiments of this application can alternatively be referred to as a system chip, a chip system, or a system-on-chip.

An embodiment of this application further provides a computer program/program product. The computer program/program product is stored in a storage medium. The computer program/program product, when executed by at least one processor, implements the processes of the terminal capability reporting processing method embodiment, and can achieve the same technical effects. To avoid repetition, details are not described herein.

An embodiment of this application further provides a wireless communication system, including a terminal and a network side device. The terminal may be configured to perform the steps of the terminal-side terminal capability reporting processing method embodiment. The network side device may be configured to perform the steps of the first access network device-side terminal capability reporting processing method embodiment.

It should be noted that in this specification, the term "include", "comprise", or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. Without more limitations, an element defined by a sentence "including one……" does not exclude existence of other same elements in the process, the method, the object, or the apparatus that includes the element. In addition, it should be noted that the scopes of the methods and apparatus in the implementations of this application are not limited to executing functions in the order shown or discussed, but may alternatively include executing functions in a substantially simultaneous manner or in an opposite order according to the functions involved. For example, the methods described may be executed in a different order than that described, and steps may alternatively be added, omitted, or combined. In addition, features described with reference to some examples may be combined in other examples.

Through the description of the above implementations, a person skilled in the art may clearly understand that the methods of the above embodiments may be implemented by a computer software product and a necessary general hardware platform, and certainly, may alternatively be implemented by hardware. The computer software product is stored in a storage medium (such as a ROM, a RAM, a magnetic disk, or an optical disc) and includes several instructions for instructing a terminal to perform the methods described in the embodiments of this application.

The embodiments of this application are described above with reference to the accompanying drawings. However, this application is not limited to the specific implementations described above, and the specific implementations described above are only exemplary and not limitative. A person of ordinary skill in the art may make implementations in many forms under the teaching of this application without departing from the spirit of this application and the protection scope of the claims, and these implementations shall all fall within the protection scope of this application.

What is claimed is:

1. A terminal capability reporting processing method, comprising:
transmitting, by a terminal, target indication information to a first access network device, wherein
the target indication information comprises at least one of first indication information or second indication information; the first indication information comprises any one of the following:
a first indication indicating at least one of the following: a target capability, reported by the terminal, conforming to a target filter, or a mirror filter, reported by the terminal, conforming to the target filter; and
a second indication indicating at least one of the following: the target capability, reported by the terminal, not conforming to the target filter, the mirror filter, reported by the terminal, not conforming to the target filter, the target capability exceeding the target filter, or the mirror filter exceeding the target filter;
the second indication information comprises at least one of the following:
a third indication indicating whether the terminal supports terminal capability filtering;
a fourth indication indicating that the terminal applies the target filter or the terminal ignores the target filter;
a fifth indication indicating a full characteristic capability; or
a sixth indication indicating that the target capability reported by the terminal is applicable to a cell to which the terminal is handed over or a cell which is selected or reselected by the terminal, wherein
the target filter is a capability request filter carried in a capability enquiry message transmitted by the first access network device.

2. The method according to claim 1, wherein the method further comprises:
receiving, by the terminal, the capability enquiry message from the first access network device, wherein the capability enquiry message carries the target filter; and
transmitting, by the terminal, a capability message to the first access network device based on the capability enquiry message, wherein the capability message comprises the target capability.

3. The method according to claim 2, wherein the target indication information is implicitly indicated through the mirror filter, and the target indication information satisfies at least one of the following:
in a case that the mirror filter is different from the target filter, the target indication information indicates at least one of the following: the terminal not supporting terminal capability filtering, the terminal not applying the target filter, or the target capability being the full characteristic capability; or
in a case that the mirror filter is the same as the target filter, the target indication information indicates at least one of the following: the terminal supporting terminal capability filtering, the terminal having used the target filter, or the target capability being the full characteristic capability.

4. The method according to claim 1, wherein the target capability comprises at least one of the following:
a first capability or a second capability; or
a third capability, wherein
the first capability comprises at least one of the following: a capability conforming to the target filter; or the mirror filter conforming to the target filter;
the second capability comprises at least one of the following: a capability not conforming to the target filter; or the mirror filter not conforming to the target filter; and
the third capability comprises at least one of the following: a capability exceeding the target filter; a capability corresponding to the mirror filter exceeding the target filter; a full characteristic capability; or a capability applicable to the cell to which the terminal is handed over or a cell which is selected or reselected by the terminal.

5. The method according to claim 1, wherein the target indication information is carried in a target message, and the target message comprises at least one of the following:
a capability message, wherein the capability message is used for reporting the target capability;
a terminal assistance information UAI message;
radio resource control RRC message; or
an uplink message in a random access channel RACH process.

6. The method according to claim 1, wherein the target filter and the mirror filter are configured to filter at least one of the following characteristics:
a supported frequency range or band;
a supported band combination;
a supported radio access technology; or
a supported feature set.

7. The method according to claim 1, wherein a type of the terminal comprises at least one of the following:
a reduced-capability terminal or an enhanced reduced-capability terminal;
an Internet of Things IOT terminal;
a vehicle to everything V2X terminal;
a device to device D2D terminal; or
a non-terrestrial network NTN terminal.

8. The method according to claim 1, wherein
in a case that a preset condition is satisfied, the target indication information comprises the second indication; and the preset condition comprises at least one of the following: a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a characteristic set supported by the terminal is limited; or the terminal has obtained a terminal capability required by a second access network device; or in a case that the terminal has obtained the terminal capability required by the second access network device, the target capability comprises at least one of the following: a capability conforming to the target filter, the terminal capability required by the second access network device, or the full characteristic capability; or, in a case that the terminal has obtained the terminal capability required by the second access network device, the target indication information comprises the second indication; or
the target indication information indicates, based on whether the target indication information carries the third indication, whether the terminal supports terminal capability filtering, wherein in a case that the target indication information carries the third indication, the target indication information indicates that the terminal does not support terminal capability filtering; and in a case that the target indication information does not carry the third indication, the target indication information indicates that the terminal supports terminal capability filtering; or
the target indication information indicates, based on whether the target indication information carries the fourth indication, that the terminal applies the target filter or the terminal ignores the target filter, wherein in a case that the target indication information carries the fourth indication, the target indication information indicates that the terminal does not use the target filter; and in a case that the target indication information does not carry the fourth indication, the target indication information indicates that the terminal has used the target filter.

9. The method according to claim 1, wherein the full characteristic capability comprises at least one of the following:
all ranges or bands supported by the terminal;
all band combinations supported by the terminal;
all radio access technologies supported by the terminal; or
all feature sets supported by the terminal.

10. The method according to claim 1, wherein the full characteristic capability is full supported capabilities corresponding to a target characteristic, and the target characteristic is a characteristic corresponding to the target filter.

11. A terminal capability reporting processing method, comprising:
receiving, by a first access network device, target indication information from a terminal, wherein
the target indication information comprises at least one of first indication information or second indication information; the first indication information comprises any one of the following:
a first indication indicating at least one of the following: a target capability, reported by the terminal, conforming to a target filter, or a mirror filter, reported by the terminal, conforming to the target filter; and
a second indication indicating at least one of the following: the target capability, reported by the terminal, not conforming to the target filter, the mirror filter, reported by the terminal, not conforming to the target filter, the target capability exceeding the target filter, or the mirror filter exceeding the target filter;
the second indication information comprises at least one of the following:
a third indication indicating whether the terminal supports terminal capability filtering;
a fourth indication indicating that the terminal applies the target filter or the terminal ignores the target filter;
a fifth indication indicating a full characteristic capability; or
a sixth indication indicating that the target capability reported by the terminal is applicable to a cell to which the terminal is handed over or a cell which is selected or reselected by the terminal, wherein
the target filter is a capability request filter carried in a capability enquiry message transmitted by the first access network device.

12. The method according to claim 11, wherein the method further comprises:
transmitting, by the first access network device, a capability enquiry message to the terminal, wherein the capability enquiry message carries the target filter; and
receiving, by the first access network device, a capability message from the terminal, wherein the capability message comprises the target capability.

13. The method according to claim 12, wherein the target indication information is implicitly indicated through the mirror filter, and the target indication information satisfies at least one of the following:
in a case that the mirror filter is different from the target filter, the target indication information indicates at least one of the following: the terminal not supporting terminal capability filtering, the terminal not applying the target filter, or the target capability being the full characteristic capability; or
in a case that the mirror filter is the same as the target filter, the target indication information indicates at least one of the following: the terminal supporting terminal capability filtering, the terminal having used the target filter, or the target capability being the full characteristic capability.

14. The method according to claim 11, wherein the target capability comprises at least one of the following:
a first capability or a second capability; or
a third capability, wherein
the first capability comprises at least one of the following: a capability conforming to the target filter; or the mirror filter conforming to the target filter;
the second capability comprises at least one of the following: a capability not conforming to the target filter; or the mirror filter not conforming to the target filter;
the third capability comprises at least one of the following: a capability exceeding the target filter; a capability corresponding to the mirror filter exceeding the target filter; a full characteristic capability; or a capability applicable to a cell to which the terminal is handed over or a cell which is selected or reselected by the terminal.

15. The method according to claim 11, wherein the target indication information is carried in a target message, and the target message comprises at least one of the following:
a capability message, wherein the capability message is used for reporting the target capability;
a terminal assistance information UAI message;
a radio resource control RRC message; or
an uplink message in a random access channel RACH process.

16. The method according to claim 11, wherein the target filter and the mirror filter are configured to filter at least one of the following characteristics:
a supported frequency range or band;
a supported band combination;
a supported radio access technology; or
a supported feature set.

17. The method according to claim 11, wherein
the target indication information indicates, based on whether the target indication information carries the third indication, whether the terminal supports terminal capability filtering, wherein in a case that the target indication information carries the third indication, the target indication information indicates that the terminal does not support terminal capability filtering; and in a case that the target indication information does not carry the third indication, the target indication information indicates that the terminal supports terminal capability filtering; or
the target indication information indicates, based on whether the target indication information carries the fourth indication, that the terminal applies the target filter or the terminal ignores the target filter, wherein in a case that the target indication information carries the fourth indication, the target indication information indicates that the terminal does not use the target filter; and in a case that the target indication information does not carry the fourth indication, the target indication information indicates that the terminal has used the target filter; or
after the receiving, by the first access network device, the target indication information from the terminal, the method further comprises: transmitting, by the first access network device, the target indication information or both the target indication information and the target capability to a target device, wherein the target device comprises at least one of a core network device or a second access network device; or
the transmitting, by the first access network device, the target indication information or both the target indication information and the target capability to a target device comprises: transmitting, by the first access network device, the target indication information or both the target indication information and the target capability to the target device in a case that the target indication information comprises the second indication information or the second indication indicates that the target capability is the full characteristic capability; or
after the receiving, by the first access network device, the target indication information from the terminal, the method further comprises: determining, by the first access network device based on the target indication information, that the terminal satisfies a preset condition, wherein the preset condition comprises at least one of the following: a processing capability of the terminal is limited; a caching capability of the terminal is limited; a processing delay of the terminal exceeds a preset threshold; the terminal does not expect to frequently report a terminal capability; a capability supported by the terminal is limited; a band supported by the terminal is limited; a band combination supported by the terminal is limited; a type of a radio access technology supported by the terminal is limited; a characteristic set supported by the terminal is limited; or the terminal has obtained a terminal capability required by a second access network device; or
the method further comprises at least one of the following: executing, by the first access network device, a first behavior in a case that the target indication information does not match the target capability; or executing, by the first access network device, a second behavior in a case that the target indication information matches the target capability; the first behavior comprises at least one of the following: determining that the target capability is invalid; determining not to transmit the target capability to the target device, wherein the target device comprises at least one of the second access network device or the core network device; and
transmitting the capability enquiry message to the terminal; and the second behavior comprises at least one of the following: determining that the target capability is valid; transmitting the target capability to the target device, wherein the target device comprises at least one of the second access network device or the core network device; and determining not to retransmit the capability enquiry message to the terminal.

18. The method according to claim 11, wherein the full characteristic capability comprises at least one of the following:
all band ranges or bands supported by the terminal;
all band combinations supported by the terminal;
all radio access technologies supported by the terminal; or
all feature sets supported by the terminal.

19. A terminal, comprising a processor and a memory, wherein the memory stores a program or an instruction executable on the processor, and the program or the instruction, when executed by the processor, implements a terminal capability reporting processing method, the method comprising:
transmitting target indication information to a first access network device, wherein
the target indication information comprises at least one of first indication information or second indication information; the first indication information comprises any one of the following:
a first indication indicating at least one of the following: a target capability, reported by the terminal, conforming to a target filter, or a mirror filter, reported by the terminal, conforming to the target filter; and
a second indication indicating at least one of the following: the target capability, reported by the terminal, not conforming to the target filter, the mirror filter, reported by the terminal, not conforming to the target filter, the target capability exceeding the target filter, or the mirror filter exceeding the target filter;
the second indication information comprises at least one of the following:
a third indication indicating whether the terminal supports terminal capability filtering;
a fourth indication indicating that the terminal applies the target filter or the terminal ignores the target filter;
a fifth indication indicating a full characteristic capability; or
a sixth indication indicating that the target capability reported by the terminal is applicable to a cell to which the terminal is handed over or a cell which is selected or reselected by the terminal, wherein
the target filter is a capability request filter carried in a capability enquiry message transmitted by the first access network device.

20. A first access network device, comprising a processor and a memory, wherein the memory stores a program or an instruction executable on the processor, and the program or the instruction, when executed by the processor, implements the steps of the terminal capability reporting processing method according to claim 11.
